(19) United States
(12) Patent Application Publication
(10) Pub. No.: US 2008/0145273 A1
(43) Pub. Date: Jun. 19, 2008

(54) Apparatus and methods for on-line monitoring of fluorinated material in headspace of vial

(75) Inventor: Varadarajan Ramaswami, Tucson, AZ (US)

Correspondence Address: DLA PIPER US LLP, 4365 EXECUTIVE DRIVE, SUITE 1100, SAN DIEGO, CA, 92121-2133, US

(73) Assignee: IMARX THERAPEUTICS, INC., Tucson, AZ (US)

(21) Appl. No.: 11/643,142

(22) Filed: Dec. 20, 2006

Related U.S. Application Data
(60) Provisional application No. 60/752,293, filed on Dec. 21, 2005.

(51) Int. Cl. G01N 35/10; G01N 29/02

(52) U.S. Cl. 422/63; 73/23.2

(57) ABSTRACT

Apparatus and methods for monitoring the presence of an analyte in a closed vial wherein a sample contained within the closed vial is conveyed to an analyzer. The analyzer determines a value of an ultrasound velocity dependent on analyte concentration at a position within a headspace formed above the sample within the vial. An indicator is used to compare the measured value of the ultrasound velocity with a predetermined limit criteria to determine the presence or absence of the analyte. Vials wherein the presence of the analyte is denominated are indicated as product vials whereas vials wherein the absence of the analyte is denominated are indicated as rejected vials. The rejected vials are conveyed by a transferrer to a rejected vial station. A first portion of the product vials are conveyed by a sampler to a sample collection station. A second portion of the product vials are conveyed to a labeler.

### RELATED APPLICATION

This application claims the benefit under 35 U.S.C. §119(e) of U.S. Provisional Application No. 60/752,293, filed Dec. 21, 2005, the entire contents of which is incorporated herein by reference.

### FIELD OF THE INVENTION

The present invention relates to apparatus and methods for the on-line monitoring of gas in the headspace of a container and, in particular, to apparatus and methods for the on-line monitoring of fluorinated material in the headspace of a pharmaceutical vial by measuring an ultrasound velocity of the material in the headspace.

### BACKGROUND OF THE INVENTION

Ultrasound is a diagnostic imaging technique which provides a number of advantages over other diagnostic methodology. Unlike techniques such as nuclear medicine and X-rays, ultrasound does not expose the patient to potentially harmful exposures of ionizing electron radiation that can potentially damage biological materials, such as DNA, RNA, and proteins. In addition, ultrasound technology is a relatively inexpensive modality when compared to such techniques as computed tomography (CT) or magnetic resonance imaging.

The principle of ultrasound is based upon the fact that sound waves will be differentially reflected off of tissues depending upon the makeup and density of the tissue or vasculature being observed. Depending upon the tissue composition, ultrasound waves will dissipate by absorption, penetrate through the tissue, or reflect back. Reflection, referred to as back scatter or reflectivity, is the basis for developing an ultrasound image. A transducer, which is typically capable of detecting sound waves in the range of 1 MHz to 10 MHz in clinical settings, is used to sensitively detect the returning sound waves. These waves are then integrated into an image that can be quantitated. The quantitated waves are then converted to an image of the tissue being observed.

Despite technical improvements to the ultrasound modality, the images obtained are still subject to further refinement, particularly in regards to imaging of the vasculature and tissues that are perfused with a vascular blood supply. Toward that end, contrast agents are typically used to aid in the visualization of the vasculature and vascular-related organs. In particular, microbubbles or vesicles are desirable as contrast agents for ultrasound because the reflection of sound at an interface created at the surface of a vesicle is extremely efficient. These vesicles are also useful in therapeutic methods in conjunction with ultrasound such as for performing surgery in the vasculature (U.S. Pat. No. 6,576,220) or effecting treatment by delivering drugs or nucleic acid materials for localized therapy (U.S. Pat. No. 5,770,222). It is known to produce suitable contrast agents comprising microbubbles by first placing an aqueous suspension or powder (i.e., a bubble coating agent), preferably comprising lipids or albumin, into a vial or container (e.g. U.S. Pat. No. 6,551,576). A gas phase is then introduced above the aqueous suspension or powder phase in the remaining portion, or headspace, of the vial. The vial is then shaken prior to use in order to form the microbubbles. It will be appreciated that, prior to shaking, the vial contains an aqueous suspension or solid phase and a gaseous phase. A wide variety of bubble or vesicle coating agents may be employed in the aqueous suspension phase or dry powder solid phase, such as those comprised of lipids (e.g. Definity, sold by BMS Medical Imaging or Imagent, developed by Alliance Pharmaceutical), those comprising proteins such as albumin (e.g. Optison sold by Amersham), albumin and dextrose (PESDA, U.S. Pat. No. 5,648,098) or polymers (U.S. Pat. No. 5,512,268). Likewise, a wide variety of different gases may be employed in the gaseous phase. In particular, however, fluorinated gases, such as sulfur hexafluoride or perfluorocarbon gases such as perfluoropropane (perflutren) may be used. See, for example, Unger et al., U.S. Pat. No. 5,769,080. Mixtures of gases are also used, such as perfluorohexane and nitrogen in Imagent. The disclosure of each of the above described patents are hereby incorporated in by reference in its entirety.

In practice, vials containing the aqueous suspension or solid phase and gas phases are prepared and sealed, significantly before use, for shipment. It would be highly beneficial to provide apparatus and methods for quickly and non-destructively detecting the presence or absence of the gas phase in the headspace of the sealed vial. The apparatus and methods should be able to determine the presence or absence of one or more specific gases, such as perfluorocarbons, including perfluoropropane (PFP), be capable of discriminating between species of fluorinated and other gases and should be accurate and robust. Further, the apparatus and methods should be practical for a manufacturing application and, in particular, should afford a low cost per analysis, simplicity of use, and a fast sample through-put rate. One method has been previously described in US Patent Application 20030087445 using infrared (IR) spectroscopy. This method is limited in that it does not discriminate between species of fluorinated gases that may be present and the types of containers which transmit IR light.

The apparatus and method of this patent may also find utility in the manufacturing of fluorinated gases by providing robust analysis of the manufactured gas product. For this purpose, the container holding the gas may be devoid of an aqueous phase and only contain the gas undergoing analysis.

### SUMMARY OF THE INVENTION

The present invention provides apparatus and methods for quickly and non-destructively detecting the presence or absence of specific fluorinated gases, such as perfluorocarbons, including perfluoropropane, and discriminating between species of fluorinated gases as well as other gases, in the headspace of sealed vials by measuring an ultrasound velocity of a material, in particular, by determining the value of ultrasound velocity that is dependent upon material concentration or composition. The apparatus and methods are accurate, robust, and practical for manufacturing applications. In particular, the present invention affords low cost per analysis, simplicity of use, and fast sample through-put rates.

In one of its aspects, the present invention relates to apparatus for monitoring the presence of an analyte in a closed container or vial by measuring an ultrasound velocity. The apparatus comprises a conveyor operatively associated with a vial feeding mechanism for receiving vials from the vial feeding mechanism. A transporter is optionally provided between the vial feeding mechanism and the conveyor for receiving vials from the vial feeding mechanism and transferring vials to the conveyor. A first vial counter operatively associated with the transporter for counting the number of vials received by the transporter. An analyzer is operatively associated with the conveyor for determining a value of an ultrasound velocity at a position within the headspaces of vials. In particular, the analyzer determines the value of ultrasound velocity that is dependent upon analyte concentration or composition. An indicator is operatively associated with the analyzer and the conveyor for indicating vials wherein the presence of the analyte is denominated as product vials, based on the value of the ultrasound velocity, and for indicating vials wherein the absence of the analyte is denominated as rejected vials, also based on the value of the ultrasound velocity. Also, the system can identify whether the ultrasound velocity or signal is good or bad. For example, when there is a misalignment of the vials, you will have an inaccurate signal (i.e. a bad signal) reported by unit and the vial would then be rejected. A transferrer is optionally provided for receiving vials from the conveyor and transferring the rejected vials to a reject station. A second vial counter is optionally operatively associated with the transferrer for counting the number of vials received by the transferrer. An optional sampler is operatively associated with the transferrer for removing a portion of the product vials from the transferrer and transferring those vials to a sample collection station. A third vial counter is optionally operatively associated with the sampler for counting the number of vials received by the sampler. An optional labeler is operatively associated with the transferrer for labeling product vials received from the transferrer. Alternatively, product vials can be transferred from the transferrer to a product collection station. A fourth vial counter is operatively associated with the transferrer for counting the number of vials transferred from the transferrer to the product collection station.

In another of its aspects, the present invention relates to methods for monitoring the presence or absence of an analyte in a closed vial by measuring an ultrasound velocity. A sample contained within a closed vial is conveyed to an analyzer. The analyzer determines a value of an ultrasound velocity dependent on analyte concentration at a position within a headspace formed above the sample within the vial. The measured value of the ultrasound velocity is compared with a predetermined limit criteria to determine the presence of the analyte. Vials wherein the presence of the analyte is denominated are indicated as product vials, whereas vials wherein the absence of the analyte is denominated are indicated as rejected vials. The rejected vials are conveyed to a rejected vial station. A first portion of the product vials are conveyed to a sample collection station and the remainder of the product vials are conveyed to a labeler.

In yet another of its aspects, the present invention relates to methods for monitoring the presence or absence of an analyte in a headspace of a sample vial by measuring an ultrasound velocity. A first ultrasound velocity analysis is performed on an analyte contained within a headspace of a test vial, wherein the concentration of the analyte in the headspace is at a predetermined level. A region containing an absorption peak specific for the analyte in the headspace of the test vial from the first analysis is then identified. A second ultrasound velocity analysis is performed on gas contained within a headspace of a sample vial containing a sample. A second region absorption peak specific for the analyte is identified from the second ultrasound velocity analysis is then compared with the first ultrasound velocity analysis to determine the presence or absence of analyte in the headspace of the sample vial. In one embodiment, the first and second regions are determined from a height of the absorption peak. Alternatively, the first and second regions are determined from an area of the absorption peak using, for example, a partial least squares algorithm or a peak height algorithm.

Furthermore, in yet another of its aspects, the present invention relates to methods for quantitatively measuring analyte in a headspace of a sample vial by measuring an ultrasound velocity. A first ultrasound velocity analysis is performed on an analyte contained within a headspace of a sample vial, wherein the concentration of the analyte in the headspace is at a predetermined level. A ultrasound velocity specific for the analyte in the headspace of the sample vial from the first ultrasound velocity measurement is then identified. In one embodiment, the ultrasound velocity specific for the analyte in the headspace of the sample vial from the first ultrasound velocity measurement is compared to a test vial. In other words, a ultrasound velocity analysis is performed on an analyte (or for a specific analyte) contained within a headspace of the test vial. These two ultrasound velocity analysis are then compared to one another, typically in the form of statistical data. For example, the ultrasound velocity analysis may be in the form of an area under the curve (AUC) depiction. If it is determined from the AUC depictions that the test vial has equal to, or greater than, the same amount of analyte as the sample vial, then the test vial has then met the requirement for the measured analyte.

In another aspect, the present invention provides a method for discerning between gas species in a vial or container. The ultrasound velocity measurement analysis is performed on an analyte contained within the vial or container and compared to the ultrasound velocity of the individual gas components.

It will be within the knowledge of the skilled person that some embodiments of the invention may require a spacer between the vials in the apparatus so as to prevent high sound wave levels traveling between the vials and saturating the analyzer. In particular, the need for a spacer between the vials will depend on the speed at which the vials pass through the detector. For example, where conveying the vial to the analyzer is carried out at high speeds (e.g. at a rate of about 150 vials per minute), it is preferred that a spacer be used between the vials. Alternatively, to prevent saturation of the analyzer at high speeds a capacitor on the preamplifier of the apparatus can be adjusted to allow for faster responses from the analyzer.

A wide variety of analytes can be present in the headspace of a sample vial in accordance with the present invention, for example, fluorinated gases (that is, a gas containing one or more fluorine molecules, such as sulfur hexafluoride), fluorocarbon gases (that is, a fluorinated gas which is a fluorinated carbon or gas), and perfluorocarbon gases (that is, a fluorocarbon gas which is fully fluorinated, such as perfluoropropane and perfluorobutane). Preferably, the analyte is a perfluorocarbon gas, such as perfluoromethane, perfluoroethane, perfluoropropane (PFP), perfluorobutane, or perfluoropentane. More preferred are gases which contain more than one fluorine atom, with perfluorocarbons (that is, fully fluorinated fluorocarbons). Preferably, the perfluorocarbon gas is selected from the group consisting of perfluoromethane, perfluoroethane, perfluoropropane, perfluorobutane, perfluoropentane, perfluorocyclobutane and mixtures thereof. More preferably, the perfluorocarbon gas is perfluoropropane or perfluorobutane, with perfluoropropane being particularly preferred. Yet another preferable gas is heptafluoropropane, including 1,1,1,2,3,3,3-heptafluoropropane and its isomer, 1,1,2,2,3,3,3-heptafluor-opropane. It is contemplated that mixtures of different types of gases, such as mixtures of a perfluorocarbon gas and another type of gas, such as air, can also be used in the compositions of the present invention. Other gases, including the gases exemplified above, would be readily apparent to one skilled in the art based on the present disclosure.

In yet another of its aspects, the present invention relates to the use of plastic vials in the above mentioned methods, so as to afford another window wherein specific analytes may be detected. In particular, a region must be determined wherein (i) the analyte has at least one ultrasound velocity feature and (ii) the plastic vial has essentially no interfering features. By interfering ultrasound velocity features is meant features which overlap the ultrasound velocity feature used to identify the analyte thereby causing the detection selectivity between the analyte and the plastic vial to be compromised. It will be further appreciated that the wavelength position and width of a specific window depends directly on the specific analyte species and the specific plastic vial.

Furthermore, in yet another of its aspects, the present invention relates to methods for quantitatively measuring analyte in a sample vial, or measuring the absence or presence of the analyte in a sample vial, wherein the analyte is a fluorinated liquid. Examples of fluorinated liquids include perfluorocarbon or a liquid perfluoroether, which are liquids at the temperature of use, including, for example, perfluorohexane, perfluoroheptane, perfluorooctane, perfluorononane, perfluorodecane, perfluorododecane, perfluorocyclohexane, perfluorodecalin, perfluorododecalin, perfluorooctyliodide, perfluorooctylbromide, perfluorotripropylamine, perfluorotributylamine, perfluorobutylethyl ether, bis(perfluoroisopropyl)ether and bis(perfluoropropyl)ether.

It is to be understood that this invention covers all appropriate combinations of the particular and preferred aspects referred to herein. Additional features and embodiments of the present invention will become apparent to those skilled in the art in view of the ensuing disclosure and appended claims.

### BRIEF DESCRIPTION OF THE DRAWINGS

The numerous objects and advantages of the present invention may be better understood by those skilled in the art by reference to the accompanying detailed description and the following drawings, in which:

FIG. 1 is a schematic view of an apparatus in accordance with the present invention.

### DETAILED DESCRIPTION OF THE INVENTION

The present invention relates to apparatus and methods for quantitatively measuring a material, such as analyte, in a headspace of a sample vial by measuring an ultrasound velocity of the material. The ultrasound velocity is the speed at which ultrasound travels in a given medium under specified conditions, such as ambient conditions. In this case, the ultrasound velocity is measured for the material in the headspace, in particular, by determining the value of ultrasound velocity that is dependent upon material concentration or composition.

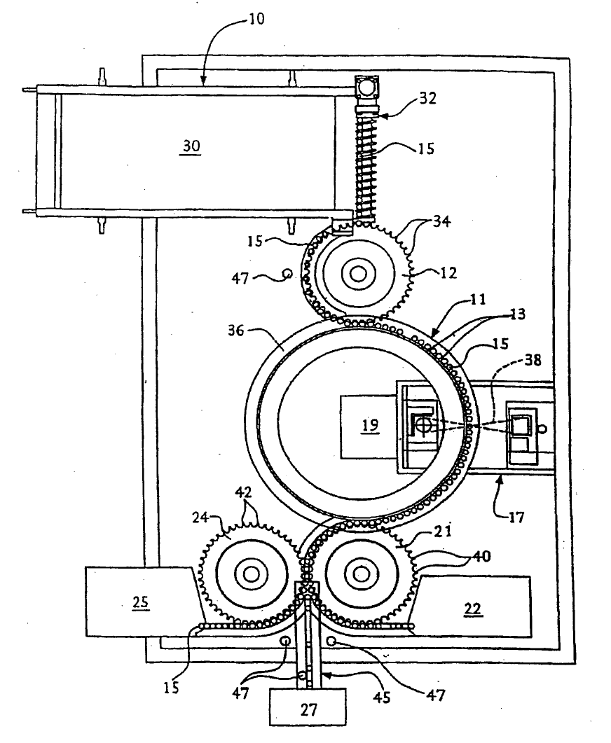

An apparatus in accordance with the present invention is depicted in FIG. 1. The apparatus comprises a vial feeding mechanism 10 for feeding vials to a conveyor 11. An optional transporter 12 is positioned between the vial feeding mechanism 10 and the conveyor 11 to facilitate the positioning of vials 15 within the conveyor 11. An analyzer 17 is operatively associated with the conveyor 11 for determining a value of an ultrasound velocity of a material at a position within headspaces of the vials 15. An indicator 19 is provided for indicating vials wherein the presence of the analyte is denominated as product vials and for indicating vials wherein the absence of the analyte is denominated as rejected vials. A transferrer 21 and a reject station 22 cooperate for receiving rejected vials from the conveyor 11. An optional sampler 24 and an optional sample collection station 25 are operatively associated with the transferrer 21 for removing sample collection vials from the transferrer 21 so that the sample collection vials can be removed for further analysis. Product vials are received from the transferrer 21 and labeled by an optional labeler 27. Alternatively, product vials are transferred by the transferrer 21 to a product collection station (not shown).

The vial feeding mechanism 10 comprises a vial storage compartment 30 configured to store a plurality of vials. A conveyor, such as linear, screw conveyor 32 is associated with the vial storage compartment 30 for conveying vials, one at a time, to the transporter 12. The pitch of the screw conveyor 32 is sized so that a single vial can be loosely held between adjacent threads.

The optional transporter 12 comprises a rotatable wheel with cogs 34 that are sized and shaped to hold one vial between adjacent cogs in a loose friction fit. The transporter 12 is positioned relative to the vial feeding mechanism 10 so that vials reaching the end of the path of the vial feeding mechanism 10 are placed between adjacent cogs 34 of the transporter 12.

The conveyor 11 comprises a rotatable wheel having a track 36 along the perimeter of the conveyor 11 for receiving vials 15 from the transporter 12. The conveyor 11 is positioned relative to the transporter 12 so that vials positioned between the cogs 34 of the transporter 12 are placed along the track 36 of the conveyor 11 as the conveyor 11 and the transporter 12 counter-rotate. Toward that end, the track 36 of the conveyor 11 is at a horizontal position that overlaps the cogs 34 of the transporter 12. The conveyor 11 is positioned, however, so that the track 36 is at a vertical position that is at, or slightly below, the level of the bottom of the vials contained within the cogs 34 of the transporter 12.

The analyzer 17 is positioned relative to the conveyor 11 so that an ultrasound wave path 38 associated with the analyzer 17 passes through the headspace of the vials positioned along the track 36 of the conveyor 11 as the conveyor 11 rotates to convey the vials through the analyzer 17. The conveyor 11 further comprises a separator 13 situated between the vials on the conveyor 11, such that the signal from the analyzer 17 does not saturate the indicator 19 as the vials 15 are moved through the wave path 38 of the analyzer 17. The analyzer 17 functions to determine a value of a velocity dependent on analyte concentration.

The analyzer 17 is also operatively associated with the indicator 19 for transmitting a signal indicative of the value of the measured ultrasound velocity to the indicator 19. The indicator 19 utilizes the signal to determine whether the analyte is present in the headspace of the vial by comparing the measured value with predetermined limits. Accordingly, the indicator 19 functions to determine, for each vial, the presence or absence of the analyte in the headspace of the vials. Vials which contain the analyte are denominated by the indicator 19 as corresponding to product vials. Similarly, vials which do not contain the analyte (or do not contain the desired concentration of analyte) are denominated by the indicator 19 as corresponding to rejected vials.

The transferrer 21 comprises a rotatable wheel with cogs 40 that are sized and shaped to hold one vial between adjacent cogs 40 in a loose friction fit. The transferrer 21 is positioned relative to the conveyor 11 so that vials positioned along the track 36 of the conveyor 11 are removed from the track 36 by the cogs 40 of the transferrer 21 as the transferrer 21 and the conveyor 11 counter-rotate. Toward that end, the cogs 40 of the transferrer 21 are at a horizontal position that overlaps the track 36 of the conveyor 11. The transferrer 21 is positioned, however, so that the cogs 40 of the transferrer 21 are at a vertical position that is above the level of the bottom of the vials contained along the track 36 of the conveyor 11. The reject station 22 is positioned relative to the transferrer 21 to receive vials from the transferrer 21. The reject station 22 functions to store rejected vials for later removal.

The sampler 24 comprises a rotatable wheel having cogs 42 that are sized and shaped to hold one vial between adjacent cogs 42 in a loose friction fit. The sampler 24 is positioned relative to the transferrer 21 so that vials contained between the cogs 40 of the transferrer 21 are removed from the transferrer 21 by the cogs 42 of the sampler 24 as the sampler 24 and the transferrer 21 counter-rotate. Toward that end, the cogs 42 of the sampler 24 are at a horizontal position that overlaps the cogs 40 of the transferrer 21. The sampler 24 is positioned, however, so that the cogs 42 of the sampler 24 are at a vertical position that is displaced from the cogs 40 of the transferrer 21, so that the sampler 24 holds the vials at a position that is vertically displaced from the position where the vials are held by the transferrer 21. The sampler 24 collects vials from the transferrer 21 at a predetermined rate. In one embodiment, the sampler 24 collects vials at a predetermined interval (e.g., every 100^{th} vial). Alternatively, the sampler 24 collects vials randomly but at a predetermined rate (e.g., 2 out of every hundred vials).

The selected product vials are removed from the transferrer 21 by the sampler 24 and then stored by the optional sample collection station 25. The selected product vials are removed manually from the sample collection station 25 and subjected to additional testing including, for example, safety or quality assurance testing.

Product vials which are not sampled by the sampler are transferred to the labeler 27 or other similar machine designed to prepare the vials for sale or shipment. The labeler 27 is operatively associated with the transferrer 21 via, for example, a linear conveyor 45. Alternatively, product vials are transferred by the transferrer to a product collection station.

One or more optional counters 47 are provided to keep account of the number of vials processed by the apparatus. For example, counters 47 are optionally associated with the transporter 12, the transferrer 21, the linear conveyor 45, and/or the sampler 24 for determining the number of vials that have been processed by the transporter 12, the transferrer 21 and the sampler 24, respectively. The counters 47 can count the number of vials using any of a number of conventional techniques, including optical sensing methods.

In operation, samples are contained within closed vials and the closed vials are placed within the vial storage compartment 30 of the apparatus. The vials are then individually conveyed to the transporter 12 by the vial feeding mechanism 10. The transporter 12 is rotated to transport the vials to the conveyor 11 and simultaneously receive additional vials from the vial feeding mechanism 10. The conveyor 11 is continually rotated to receive vials from the transporter 12 and simultaneously convey the vials through the analyzer 17. As the vials pass through the analyzer 17, the value of an ultrasonic velocity dependent on analyte concentration is determined at a position within the headspace formed above the sample within the vial. A signal that is representative of the measured value of the velocity is transmitted by the analyzer 17 to the indicator 19 where it is compared to predetermined limit criteria to determine the presence or absence of analyte in the headspace. Since the indicator 19 is also operatively associated with the conveyor 11, the indicator 19 also functions to denominate vials, wherein the presence of the analyte is denominated as product vials and the absence of the analyte is denominated as rejected vials. As the conveyor 11 continues to rotate, the vials are transferred from the conveyor 11 to the rotating transferrer 21. The transferrer 21 transports the vials to the sampler 24. The sampler 24 removes a portion of the product vials from the transferrer 21 and transfers those vials to the sample collection station 25. The transferrer 21 then transports the remaining vials to the conveyor 45 associated with the labeler 27. The conveyor 45 associated with the labeler 27 removes the remaining product vials from the transferrer 21 and conveys them to the labeler 27. At this point, the vials remaining in the transferrer 21 are only the rejected vials, which are transferred by the transferrer 21 to the rejected vial station 22.

Two methods may be used for calculating the correlation between the ultrasound velocity and analyte concentrations were used. The first method is a linear regression calculation using two factors such as changes in absorption peak height at a given wavelength and the known concentration of the analyte. The second method involves using a partial least squares (PSL) modeling algorithm in which all of the spectral data points for the spectral region spanning the absorption peak are iteratively fit to a set of linear regression equations as a function of analyte concentration (see, for example, H. Martens & T. Naes, “Multivariate Calibration” (1989) John Wiley & Sons, p. 188 ff.).

Those skilled in the art will appreciate that numerous changes and modifications may be made to the preferred embodiments of the invention and that such changes and modifications may be made without departing from the spirit of the invention. For example, the apparatus and methods of the present invention can be used to monitor the presence or absence of a variety of gases in the headspace of a vial provided that an ultrasound velocity, specific for the selected gas and indicative of the concentration of the selected gas, can be identified and measured.

What is claimed is:

1. An apparatus for monitoring the presence of an analyte in a closed vial comprising:
a vial feeding mechanism;
a conveyor operatively associated with the vial feeding mechanism for receiving vials from the vial feeding mechanism;
an analyzer operatively associated with the conveyor for determining a value of an ultrasound velocity at a position within headspaces of the vials for determining the presence of the analyte, the ultrasound velocity being dependent on analyte concentration within the headspace; and
an indicator operatively associated with the analyzer and the conveyor for denominating vials, wherein the vials in which the analyte is present is denominated as product vials and the vials in which the analyte is absent is denominated as rejected vials.

2. The apparatus of claim 1, further comprising a transporter operatively associated with the vial feeding mechanism for receiving vials from the vial feeding mechanism and operatively associated with the conveyor for transferring vials to the conveyor.

3. The apparatus of claim 2, further comprising a first vial counter operatively associated with the transporter for counting the number of vials received by the transporter.

4. The apparatus of claim 1, further comprising a transferrer for receiving vials from the conveyor.

5. The apparatus of claim 4, further comprising a reject station operatively associated with the transferrer for receiving rejected vials from the transferrer.

6. The apparatus of claim 4, further comprising a second vial counter operatively associated with the transferrer for counting the number of vials received by the transferrer.

7. The apparatus of claim 4, further comprising a sampler operatively associated with the transferrer for removing sample collection vials from the transferrer.

8. The apparatus of claim 7, further comprising a third vial counter operatively associated with the sampler for counting the number of vials received by the sampler.

9. The apparatus of claim 7, further comprising a sample collection station operatively associated with the sampler for receiving the sample collection vials from the sampler.

10. The apparatus of claim 4, further comprising a labeler operatively associated with the transferrer for labeling product vials received from the transferrer.

11. The apparatus of claim 1, wherein the analyte comprises a perfluorocarbon gas.

12. The apparatus of claim 11 wherein the perfluorocarbon gas comprises perfluoropropane.

13. The apparatus of claim 1, further comprising a separator situated between the vials on the conveyor, such that the signal from the analyzer does not saturate the indicator as the vials are moved through the path of the analyzer.

14. A method for monitoring the presence of an analyte in a closed vial comprising:
conveying a sample contained within the closed vial to an analyzer;
determining a value of a ultrasound velocity dependent on analyte concentration at a position within a headspace formed above the sample within the vial for determining the presence of the analyte;
comparing the measured value of the ultrasound velocity with a predetermined limit criteria to determine the presence of the analyte;
denominating vials, wherein the vials in which the analyte is present is denominated as product vials and the vials in which the analyte is absent is denominated as rejected vials;
conveying the rejected vials to a rejected vial station;
conveying a first portion of the product vials to a sample collection station; and
conveying a second portion of the product vials to a labeler.

15. The method of claim 15, wherein the analyte comprises a perfluorocarbon gas.

16. The method of claim 16, wherein the perfluorocarbon gas comprises perfluoropropane.

17. A method for monitoring the presence of an analyte in a headspace of a sample vial comprising:
performing a first ultrasound velocity analysis of an analyte contained within a headspace of a test vial for determining the presence of the analyte, wherein the concentration of the analyte in the headspace is at a predetermined level;
identifying a velocity containing an absorption peak specific for the analyte in the headspace of the test vial from the first ultrasound velocity analysis;
determining a first velocity for the identified velocity from the first ultrasound velocity analysis;
performing a second ultrasound velocity analysis of gas contained within a headspace of a sample vial containing a sample;
determining a second velocity for the identified velocity from the second ultrasound velocity analysis;
comparing the second velocity with the first velocity to determine the presence of the analyte in the headspace of the sample vial.

18. The method of claim 17, wherein the velocity identified is a velocity region.

19. The method of claim 17, wherein the first and second velocities are determined from a height of the absorption peak.

20. The method of claim 17, wherein the first and second velocities are determined from an area of the absorption peak.

21. The method of claim 20, wherein the area of the absorption peak is determined using a partial least squares algorithm or a peak height algorithm.

22. The method of claim 17, wherein the analyte comprises a perfluorocarbon gas.

23. The method of claim 22, wherein the perfluorocarbon gas comprises perfluoropropane.

24. An apparatus for quantitatively monitoring the presence of an analyte in a closed vial comprising:
a vial feeding mechanism;
a conveyor operatively associated with the vial feeding mechanism for receiving vials from the vial feeding mechanism;
an analyzer operatively associated with the conveyor for determining a value of an ultrasound velocity at a position within headspaces of the vials, the ultrasound velocity being dependent on analyte concentration; and
an indicator operatively associated with the analyzer and the conveyor for denominating vials, wherein the presence of the analyte is measured quantitatively and denominated as product vials, and for indicating vials wherein the quantity of analyte measured is different than the analyte in the product vials, these vials are denominated as rejected vials.

25. The apparatus of claim 24, further comprising a transporter operatively associated with the vial feeding mechanism for receiving vials from the vial feeding mechanism and operatively associated with the conveyor for transferring vials to the conveyor.

26. The apparatus of claim 25, further comprising a first vial counter operatively associated with the transporter for counting the number of vials received by the transporter.

27. The apparatus of claim 24, further comprising a transferrer for receiving vials from the conveyor.

28. The apparatus of claim 27, further comprising a reject station operatively associated with the transferrer for receiving rejected vials from the transferrer.

29. The apparatus of claim 27, further comprising a second vial counter operatively associated with the transferrer for counting the number of vials received by the transferrer.

30. The apparatus of claim 27, further comprising a sampler operatively associated with the transferrer for removing sample collection vials from the transferrer.

31. The apparatus of claim 30, further comprising a third vial counter operatively associated with the sampler for counting the number of vials received by the sampler.

32. The apparatus of claim 30, further comprising a sample collection station operatively associated with the sampler for receiving the sample collection vials from the sampler.

33. The apparatus of claim 27, further comprising a labeler operatively associated with the transferrer for labeling product vials received from the transferrer.

34. The apparatus of claim 24, wherein the analyte comprises a perfluorocarbon gas.

35. The apparatus of claim 34, wherein the perfluorocarbon gas comprises perfluoropropane.

36. The apparatus of claim 34, further comprising a separator situated between the vials on the conveyor, such that the signal from the analyzer does not saturate the indicator as the vials are moved through the path of the analyzer.

37. A method for quantitatively measuring an analyte in a closed vial comprising:
conveying a sample contained within the closed vial to an analyzer;
determining a value of a ultrasound velocity dependent on analyte concentration at a position within a headspace formed above the sample within the vial;
comparing the measured value of the ultrasound velocity with a predetermined limit criteria to determine the quantity of the analyte;
denominating vials, wherein vials having the desired quantity of analyte are denominated as product vials and vials having the undesired quantity of analyte are denominated as rejected vials;
conveying the rejected vials to a rejected vial station;
conveying a first portion of the product vials to a sample collection station; and
conveying a second portion of the product vials to a labeler.

38. The method of claim 37, wherein the analyte comprises a perfluorocarbon gas.

39. The method of claim 38, wherein the perfluorocarbon gas comprises perfluoropropane.

40. A method for quantitatively monitoring the presence of an analyte in a headspace of a sample vial comprising:
performing a first ultrasound velocity analysis of an analyte contained within a headspace of a test vial, wherein the concentration of the analyte in the headspace is at a predetermined level;
identifying a velocity containing an absorption peak specific for the analyte in the headspace of the test vial from the first ultrasound velocity analysis;
determining a first velocity for the identified velocity from the first ultrasound velocity analysis;
performing a second ultrasound velocity analysis of gas contained within a headspace of a sample vial containing a sample;
determining a second velocity for the identified velocity from the second ultrasound velocity analysis; and
comparing the second velocity with the first velocity to determine the quantity of the analyte in the headspace of the sample vial.

41. The method of claim 40, wherein the velocity identified is a velocity region.

42. The method of claim 40, wherein the first and second velocities are determined from a height of the absorption peak.

43. The method of claim 40, wherein the first and second velocities are determined from an area of the absorption peak.

44. The method of claim 43, wherein the area of the absorption peak is determined using a partial least squares algorithm or a peak height algorithm.

45. The method of claim 40, wherein the analyte comprises a perfluorocarbon gas.

46. The method of claim 45, wherein the perfluorocarbon gas comprises perfluoropropane.

47. The method of claim 14, wherein the analyte comprises a gas selected from the group: fluorinated gas, fluorocarbon gas and perfluorocarbon gas.

48. The method of claim 14, wherein the analyte comprises a perfluorocarbon gas selected from the group: perfluoromethane, perfluoroethane, perfluoropropane (PFP), perfluorobutane, and perfluoropentane, perfluorobutane, heptafluoropropane and mixtures thereof.

49. The method of claim 14, wherein the analyte comprises a fluorinated liquid.

50. The method of claim 14, wherein the analyte comprises a fluorinated liquid selected from the group consisting of: liquid perfluorocarbon and liquid perfluoroether.

51. The method of claim 49, wherein the fluorinated liquid is selected from the group consisting of: perfluorohexane, perfluoroheptane, perfluorooctane, perfluorononane, perfluorodecane, perfluorododecane, perfluorocyclohexane, perfluorodecalin, perfluorododecalin, perfluorooctyliodide, perfluorooctylbromide, perfluorotripropylamine, perfluorotributylamine, perfluorobutylethyl ether, bis(perfluoroisopropyl)ether and bis(perfluoropropyl)ether, and mixtures thereof.

52. The method of claim 14, wherein the vial is a plastic vial capable of affording a window through which specific analytes may be detected.
